(19) United States
(12) Patent Application Publication
(10) Pub. No.: US 2025/0069421 A1
(43) Pub. Date: Feb. 27, 2025

(54) CELL SEGMENTATION AND TYPING METHOD, DEVICE, APPARATUS AND MEDIUM BASED ON MACHINE LEARNING

(71) Applicants: BEIHANG UNIVERSITY, Beijing (CN); PEKING UNIVERSITY CANCER HOSPITAL & INSTITUTE, Beijing (CN)

(72) Inventors: Shuhua YUE, Beijing (CN); Xun CHEN, Beijing (CN); Zhouqiao WU, Beijing (CN); Ziyu LI, Beijing (CN); Jiafu JI, Beijing (CN); Zhongwu LI, Beijing (CN)

(73) Assignees: BEIHANG UNIVERSITY, Beijing (CN); PEKING UNIVERSITY CANCER HOSPITAL & INSTITUTE, Beijing (CN)

(21) Appl. No.: 18/725,079

(22) PCT Filed: Nov. 10, 2022
(86) PCT No.: PCT/CN2022/130989

§ 371 Date: Jun. 27, 2024

(30) Foreign Application Priority Data
Dec. 29, 2021 (CN) 202111628829.2

(51) Int. Cl. G06V 20/69; G06T 7/00; G06T 7/10; G06V 10/44; G06V 10/762; G06V 10/771

(52) U.S. Cl. CPC G06V 20/698; G06T 7/0012; G06T 7/10; G06V 10/44; G06V 10/762; G06V 10/771; G06V 20/695; G06T 2207/30096

(57) ABSTRACT

The present disclosure provides a cell segmentation and typing method, device, apparatus and medium based on machine learning. The method includes: acquiring at least one cell metabolism image of a target object; performing single cell image segmentation on the at least one cell metabolism image by using a machine learning segmentation model to obtain a plurality of single cell metabolism images; performing single cell feature extraction on each single cell metabolism image of the plurality of single cell metabolism images to obtain a single cell image feature map corresponding to the single cell metabolism image; combining the single cell image feature map corresponding to each single cell metabolism image of the plurality of single cell metabolism images to obtain an image feature map of the target object; performing typing of the cell by clustering the image feature map of the target object.

The present application claims the priority of Chinese patent application No. 202111628829.2 filed on Dec. 29, 2021, and the disclosure of the above-mentioned Chinese patent application is hereby incorporated in its entirety as a part of the present application.

### TECHNICAL FIELD

The present disclosure relates to a field of image segmentation and typing, and more specifically, to a cell segmentation and typing method, device, apparatus and medium based on machine learning.

### BACKGROUND

At present, cancer cells (such as gastric cancer cells and lung cancer cells) and information related to the cancer cells such as the number of cancer cells, etc. are determined by cytopathological detection of exfoliated cells (such as detection based on H&E or RAP staining) in clinic. However, the above detection methods are greatly influenced by subjective factors of pathologists, and for different cases, the consistency between different pathologists is also poor, and its sensitivity is often low (generally less than 60%).

In addition, the cytopathological detection is different from histopathology. And cytopathological detection lacks tissue localization information, and cells are damaged after processing such as dyeing, smearing, fixing, etc., which makes it difficult to realize accurate quantification of a single cell, which is very unfavorable for subsequent judgment of a lesion degree of a target object.

Therefore, a new method is needed to solve the above problem.

### SUMMARY

In view of the above problems, the present disclosure provides a cell segmentation and typing method based on machine learning. The method provided by the present disclosure is not influenced by the subjective factors of pathologists, and can avoid damage to cell morphology and realize accurate cell typing, thereby determining the lesion degree of the target object.

An embodiment of the disclosure provides a cell segmentation and typing method based on machine learning, which includes: acquiring at least one cell metabolism image of a target object; performing single cell image segmentation on the at least one cell metabolism image by using a machine learning segmentation model to obtain a plurality of single cell metabolism images; performing single cell feature extraction on each single cell metabolism image of the plurality of single cell metabolism images to obtain a single cell image feature map corresponding to the single cell metabolism image, wherein the single cell image feature map at least comprises a cell metabolism feature; combining the single cell image feature map corresponding to each single cell metabolism image of the plurality of single cell metabolism images to obtain an image feature map of the target object; performing typing of the cell by clustering the image feature map of the target object, wherein the typing indicates a cell type to which the cell belongs.

According to an embodiment of the present disclosure, wherein the performing typing of the cell by clustering the image feature map of the target object includes: clustering the image feature map of the target object to obtain the number of different types of cells; performing the typing of the cell based on the number of the different types of cells.

According to an embodiment of the present disclosure, wherein the image feature map of the target object is clustered by at least one of following ways to obtain the number of different types of cells: K-means clustering way, hierarchical clustering way, self-organizing map clustering way and fuzzy c-means clustering way.

According to an embodiment of the present disclosure, wherein the typing of the cell is performed based on the number of the different types of cells by at least one of following classifiers: a support vector machine classifier, a linear discriminant classifier, a K neighborhood classifier, a logistic regression classifier, a random forest decision tree classifier, an artificial neural network classifier and a deep learning convolutional neural network classifier.

According to an embodiment of the present disclosure, wherein the method further comprises: performing principal component analysis on the image feature map of the target object to obtain principal component information corresponding to each single cell image feature map, wherein the principal component information of different types of cells is different; obtaining a metabolism feature target of the same type of cells based on the principal component information; determining a lesion degree of the target object according to the metabolism feature target.

According to an embodiment of the present disclosure, wherein the determining a lesion degree of the target object according to the metabolism feature targets includes: inputting the number of the different types of cells and the metabolism feature target of the same type of cells into a pre-trained machine learning classification model to determine the lesion degree of the target object.

According to an embodiment of the present disclosure, wherein the performing single cell image segmentation on the at least one cell metabolism image by using a machine learning segmentation model to obtain a plurality of single cell metabolism images includes: performing the single cell image segmentation on the at least one cell metabolism image by using a neural network based on transfer learning to obtain the plurality of single cell metabolism images.

According to the embodiment of the present disclosure, wherein the performing single cell image segmentation on the at least one cell metabolism image by using a machine learning segmentation model to obtain a plurality of single cell metabolism images includes: performing the single cell image segmentation for a first time on the at least one cell metabolism image by using a neural network based on transfer learning; performing segmentation for a second time on an image after the single cell segmentation for the first time by using a watershed segmentation method or a flood-fill segmentation method, to obtain the plurality of single cell metabolism images.

According to an embodiment of the present disclosure, wherein the single cell image feature map further includes a cell morphological feature.

According to an embodiment of the present disclosure, wherein the cell morphological feature includes at least one of: cell area, cell shape round, cell boundary circularity, cell center, cell center eccentricity, equivalent diameter, cell perimeter, major axis length, minor axis length, major axis/minor axis ratio and major axis/minor axis rotation angle.

According to an embodiment of the present disclosure, wherein, the cell metabolism feature includes at least one of: lipid intensity, lipid concentration, protein intensity, protein concentration, deoxyribonucleic acid concentration, lipid/protein intensity ratio, lipid/protein concentration ratio, lipid/deoxyribonucleic acid concentration ratio, the number of lipid droplets, lipid droplet area, ratio of lipid droplet area to total cell area, lipid/protein concentration ratio in lipid droplet range, lipid component/protein component area ratio, lipid component/deoxyribonucleic acid component area ratio, ratio of lipid component to total cell area, ratio of protein component to total cell area and lipid/protein concentration ratio in lipid component range.

According to an embodiment of the present disclosure, wherein the combining the single cell image feature map corresponding to each single cell metabolism image of the plurality of single cell metabolism images to obtain an image feature map of the target object includes: arranging the single cell image feature map corresponding to each single cell metabolism image of the plurality of single cell metabolism images in a predetermined order to obtain the image feature map of the target object.

Accord to an embodiment of that present disclosure, wherein the cell metabolism image is an image based on Raman imaging.

Accord to an embodiment of that present disclosure, wherein the cell type comprises a cancer cell, an immune cell, a lymph cell, a dermal cell, an epithelial cell, a blood cell or a granulocyte.

An embodiment of the present disclosure provides a cell segmentation and typing device based on machine learning, including: an acquisition module configured to acquire at least one cell metabolism image of a target object; a segmentation module configured to perform single cell image segmentation on the at least one cell metabolism image by using a machine learning segmentation model to obtain a plurality of single cell metabolism images; a feature extraction module configured to perform single cell feature extraction on each single cell metabolism image of the plurality of single cell metabolism images to obtain a single cell image feature map corresponding to the single cell metabolism image, wherein the single cell image feature map at least comprises a cell metabolism feature; a map combining module configured to combine the single cell image feature map corresponding to each single cell metabolism image of the plurality of single cell metabolism images to obtain an image feature map of the target object; a typing module configured to perform typing of the cell by clustering the image feature map of the target object, wherein the typing indicates a cell type to which the cell belongs.

According to an embodiment of the present disclosure, wherein the typing module includes: clustering the image feature map of the target object to obtain the number of different types of cells; performing the typing of the cell based on the number of the different types of cells.

According to an embodiment of the present disclosure, wherein the image feature map of the target object is clustered by at least one of following ways to obtain the number of different types of cells: K-means clustering way, hierarchical clustering way, self-organizing map clustering way and fuzzy c-means clustering way.

According to an embodiment of the present disclosure, wherein the typing of the cell is performed based on the number of the different types of cells by at least one of following classifiers: a support vector machine classifier, a linear discriminant classifier, a K neighborhood classifier, a logistic regression classifier, a random forest decision tree classifier, an artificial neural network classifier and a deep learning convolutional neural network classifier.

According to an embodiment of the present disclosure, wherein the device further includes: a principal component analysis module configured to perform principal component analysis on the image feature map of the target object to obtain principal component information corresponding to each single cell image feature map, wherein the principal component information of different types of cells is different; a target obtaining module configured to obtain a metabolism feature target of the same type of cells based on the principal component information; a lesion determination module configured to determine a lesion degree of the target object according to the metabolism feature target.

According to an embodiment of the present disclosure, wherein the lesion determination module includes: inputting the number of the different types of cells and the metabolism feature target of the same type of cells into a pre-trained machine learning classification model to determine the lesion degree of the target object.

According to an embodiment of the present disclosure, wherein the segmentation module includes: performing the single cell image segmentation on the at least one cell metabolism image by using a neural network based on transfer learning to obtain the plurality of single cell metabolism images.

According to an embodiment of the present disclosure, wherein the segmentation module includes: a first time segmentation module configured to perform the single cell image segmentation for a first time on the at least one cell metabolism image by using a neural network based on transfer learning; a second time segmentation module configured to perform segmentation for a second time on an image after the single cell segmentation for the first time by using a watershed segmentation method or a flood-fill segmentation method, to obtain the plurality of single cell metabolism images.

According to an embodiment of the present disclosure, wherein the single cell image feature map further includes a cell morphological feature.

According to an embodiment of the present disclosure, wherein the cell morphological feature includes at least one of: cell area, cell shape round, cell boundary circularity, cell center, cell center eccentricity, equivalent diameter, cell perimeter, major axis length, minor axis length, major axis/minor axis ratio and major axis/minor axis rotation angle

According to an embodiment of the present disclosure, wherein, the cell metabolism feature includes at least one of: lipid intensity, lipid concentration, protein intensity, protein concentration, deoxyribonucleic acid concentration, lipid/protein intensity ratio, lipid/protein concentration ratio, lipid/deoxyribonucleic acid concentration ratio, the number of lipid droplets, lipid droplet area, ratio of lipid droplet area to total cell area, lipid/protein concentration ratio in lipid droplet range, lipid component/protein component area ratio, lipid component/deoxyribonucleic acid component area ratio, ratio of lipid component to total cell area, ratio of protein component to total cell area and lipid/protein concentration ratio in lipid component range.

According to an embodiment of the present disclosure, wherein the map combining module includes: arranging the single cell image feature map corresponding to each single cell metabolism image of the plurality of single cell metabolism images in a predetermined order to obtain the image feature map of the target object.

According to an embodiment of the present disclosure, wherein the cell metabolism image is an image based on Raman imaging.

According to an embodiment of the present disclosure, wherein the cell type comprises a cancer cell, an immune cell, a lymph cell, a dermal cell, an epithelial cell, a blood cell or a granulocyte.

An embodiment of the present disclosure provides a cell segmentation and typing apparatus based on machine learning, including: a processor, and a memory storing computer-executable instructions which, when executed by the processor, cause the processor to perform the above method.

An embodiment of the present disclosure provides a computer-readable recording medium storing computer-executable instructions, wherein the computer-executable instructions, when executed by a processor, cause the processor to perform the above method.

An embodiment of the present disclosure provides an apparatus for performing image segmentation by a deep neural network model, which includes a processor and a memory, wherein the memory stores computer executable instructions, and the computer executable instructions, when executed by the processor, cause the processor to perform the above method.

An embodiment of the present disclosure provides a computer-readable recording medium storing computer-executable instructions, wherein the computer-executable instructions, when executed by a processor, cause the processor to perform the above method.

Embodiments of the present disclosure provide a cell segmentation and typing method, device, apparatus and medium based on machine learning. According to the cell segmentation and typing method based on machine learning provided by the present disclosure, a cell may be accurately segmented by using a machine learning segmentation model, and the cell can be accurately typed by clustering a feature map of the cell, so as to accurately judge a lesion degree of a target object. The method provided by the present disclosure effectively avoids the influence of the pathologist's subjective factors, and does not need to damage the cell morphology.

### BRIEF DESCRIPTION OF DRAWINGS

In order to explain technical schemes of embodiments of the present disclosure more clearly, the drawings needed in the description of the embodiments will be briefly introduced below. Obviously, the drawings in the following description are only some exemplary embodiments of the present disclosure, and other drawings can be obtained according to these drawings without creative work for ordinary skilled people in the art.

FIG. 1 is a flowchart showing a cell segmentation and typing method based on machine learning according to an embodiment of the present disclosure;

FIG. 2 is an effect diagram showing single cell segmentation on a cell metabolism image according to a machine learning segmentation model provided by the present disclosure;

FIG. 3A shows a distribution diagram of lipid intensity in an obtained single cell image feature map corresponding to a single cell metabolism image;

FIG. 3B shows a feature map obtained for this single case;

FIG. 3C shows a schematic diagram of cancer cells and normal cells;

FIG. 4 shows an example diagram of a cell segmentation and typing method according to an embodiment of the present disclosure;

FIG. 5 shows an effect diagram of single cell typing for positive cell lines and negative cell lines;

FIG. 6 shows a schematic diagram of values of a significant difference parameter (p-value) of metabolism features;

FIG. 7 shows a schematic diagram showing sensitivity and specificity of realizing diagnosis of a peritoneal metastasis case of a gastric cancer using single cell metabolism imaging;

FIG. 8 shows a block diagram of a cell segmentation and typing device 800 based on machine learning according to an embodiment of the present disclosure;

FIG. 9 shows a structural diagram of a cell segmentation and typing apparatus 900 based on machine learning according to an embodiment of the present disclosure.

### DETAILED DESCRIPTION

In order to make the objects, technical solutions and advantages of the present disclosure more obvious, exemplary embodiments according to the present disclosure will be described in detail below with reference to the accompanying drawings. Obviously, the described embodiments are only a part of the embodiments of the present disclosure, not all the embodiments of the present disclosure, and it should be understood that the present disclosure is not limited by the example embodiments described here.

In this specification and the drawings, basically the same or similar steps and elements are denoted by the same or similar reference numerals, and repeated descriptions of these steps and elements will be omitted. Meanwhile, in the description of this disclosure, the terms “first”, “second” and so on are only used to distinguish descriptions, and cannot be understood as indicating or implying relative importance or ranking.

At present, the methods to determine the information related to cancer cells in clinic are greatly influenced by the subjective factors of pathologists, and the consistency is poor, and it will also cause damage to the cell morphology, which is very unfavorable for the subsequent judgment of the lesion degree of the target object.

In order to solve the above problems, the present disclosure provides a cell segmentation and typing method based on machine learning. According to the method provided by the present disclosure, a cell can be accurately segmented by using a machine learning segmentation model, and the cell can be accurately typed by clustering the feature map of the cell, so as to accurately judge the lesion degree of the target object. The method provided by the present disclosure effectively avoids the influence of the pathologist's subjective factors, and does not need to damage the cell morphology.

Next, the cell segmentation and typing method based on machine learning provided by the present disclosure will be described in detail with reference to the attached drawings.

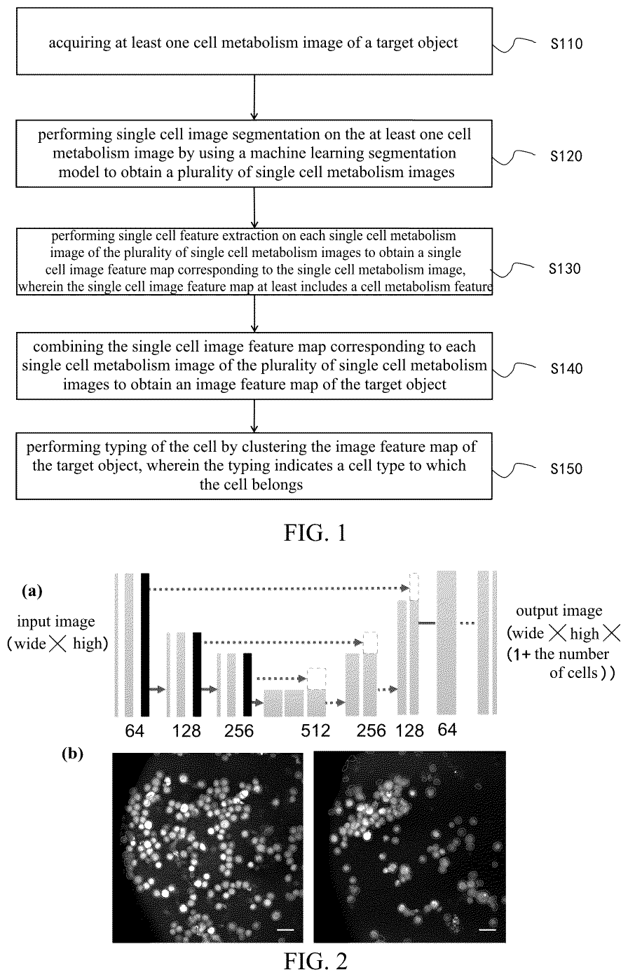

FIG. 1 is a flowchart showing a cell segmentation and typing method based on machine learning according to an embodiment of the present disclosure.

The method provided by the present disclosure may perform cell segmentation and typing based on unlabeled stimulated Raman imaging (such as imaging based on Stimulated Raman Scattering (SRS)). Stimulated Raman technology uses a wavelength difference of two lasers to excite molecular vibration of specific chemical bonds in C—H region.

Referring to FIG. 1, at step S110, at least one cell metabolism image of a target object may be acquired.

As an example, the target object may be an organ or tissue such as a stomach and lung in a human body. The target object can also be exfoliated cells obtained from an organ or tissue in the human body, such as exfoliated cells obtained from the stomach, to judge the situation of gastric cancer cells.

As an example, the cell metabolism image may be an image based on Raman imaging.

As an example, the cell metabolism image can be obtained through a channel, such as a protein channel, a lipid channel or a DNA channel.

As another example, the cell metabolism image may be obtained through a plurality of channels, for example, three channels including a protein channel, a lipid channel and a DNA channel.

As an example, for a single case (such as a gastric cancer case or a lung cancer case), the above-mentioned at least one cell metabolism image may be obtained through one or more channels.

In step S120, single cell image segmentation may be performed on the at least one cell metabolism image by using a machine learning segmentation model to obtain a plurality of single cell metabolism images.

According to the embodiment of the present disclosure, the performing of the single cell image segmentation on the at least one cell metabolism image by using a machine learning segmentation model to obtain a plurality of single cell metabolism images may include: performing the single cell image segmentation on the at least one cell metabolism image by using a neural network based on transfer learning to obtain the plurality of single cell metabolism images.

As an example, the above contents may be trained by the transfer learning using an existing database and neural network segmentation model for the single cell segmentation (such as a database and neural network segmentation model about the single cell segmentation of a fluorescence image), and a small amount of stimulated Raman cell images and manual labeling data, that is, the machine learning segmentation model that needs to be used may be obtained, so as to realize high-precision segmentation for the single cell metabolism image.

Different from the traditional image segmentation method based on neural network algorithm, the image segmentation method provided by the present disclosure avoids the collection of a large number of clinical data and a large number of manual (such as pathologists and experts) labeling due to using the machine learning segmentation model based on the transfer learning, which greatly shortens the development cycle of a related learning model and greatly promotes the clinical application of single cell metabolism imaging technology.

According to the embodiment of the present disclosure, the performing of single cell image segmentation on the at least one cell metabolism image by using a machine learning segmentation model to obtain a plurality of single cell metabolism images may include: performing the single cell image segmentation for a first time on the at least one cell metabolism image by using a neural network based on transfer learning; performing segmentation for a second time on an image after the single cell segmentation for the first time by using a watershed segmentation method or a flood-fill segmentation method, to obtain the plurality of single cell metabolism images.

As an example, the above contents may be trained by the transfer learning using an existing database and neural network segmentation model for the single cell segmentation (such as a database and neural network segmentation model about the single cell segmentation of a fluorescence image), and a small amount of stimulated Raman cell images and manual labeling data, that is, the neural network based on the transfer learning that needs to be used may be obtained to segment the cell metabolism image for the first time. In the cell metabolism image after the single cell image segmentation for the first time, there may be a problem that the cells are very close to each other, resulting in insufficient segmentation. In order to further improve the accuracy of the single cell segmentation, the image after the single cell segmentation for the first time may be segmented for the second time by using the watershed segmentation method (such as WaterShed segmentation algorithm) or the flood-fill segmentation method (such as flood-fill algorithm) to obtain the plurality of single cell metabolism images.

Compared with the traditional method of the single cell segmentation by manual circling, the segmentation method provided by the present disclosure may have excellent values in related parameters for evaluating the effect of the single cell segmentation, such as the value of f1 score parameter may reach 95%, and the value of DICE parameter may reach 89%. FIG. 2 shows an effect diagram of the single cell segmentation of a cell metabolism image according to a machine learning segmentation model provided by the present disclosure, wherein (a) in FIG. 2 represents a conceptual diagram of the machine learning segmentation model provided by the present disclosure, and 64, 128, 256 and 512 respectively indicate that the size of a convolution kernel is 64×64, 128×128, 256×256 and 512×512 respectively, (b) in FIG. 2 shows an effect diagram of the single cell image segmentation on two cell metabolism images, in which a plurality of single cell metabolism images are segmented. From the effect diagram, it can be seen that the machine learning segmentation model provided by the present disclosure may perform the single cell image segmentation on the cell metabolism image very accurately. In addition, the machine learning segmentation model provided by the present disclosure is not limited to perform the single cell image segmentation on the above-mentioned cell metabolism image. In fact, the machine learning segmentation model provided by the present disclosure may perform single cell segmentation on any image, such as the single cell image segmentation on an image through fluorescence imaging and an image taken by immunohistochemical imaging.

Continuing to refer to FIG. 1, in step S130, single cell feature extraction may be performed on each single cell metabolism image of the plurality of single cell metabolism images to obtain a single cell image feature map corresponding to the single cell metabolism image, wherein the single cell image feature map at least includes a cell metabolism feature.

As an example, single cell features may be extracted by any known way, such as measurement, calculation, etc. A plurality of single cell features may be extracted from each single cell metabolism image, and the single cell image feature map may be obtained by combining (such as arranging) the plurality of single cell features.

As an example, the cell metabolism feature may include at least one of: lipid intensity, lipid concentration, protein intensity, protein concentration, deoxyribonucleic acid (DNA) concentration, Lipid/Protein Intensity ratio, lipid/protein concentration ratio, lipid/deoxyribonucleic acid concentration ratio, the number of lipid droplets, lipid droplet area, ratio of lipid droplet area to total cell area, lipid/protein concentration ratio in lipid droplet range, lipid component/protein component area ratio, lipid component/deoxyribonucleic acid component area ratio, ratio of lipid component to total cell area (Lipid Area Fraction), ratio of protein component to total cell area, and lipid/protein concentration ratio in lipid component range.

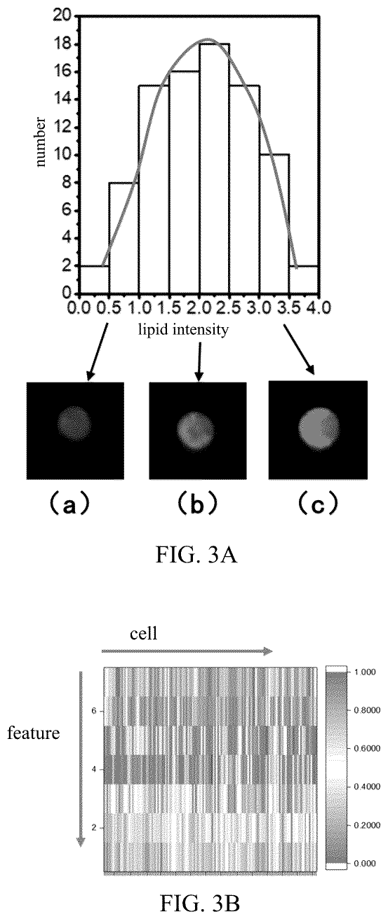

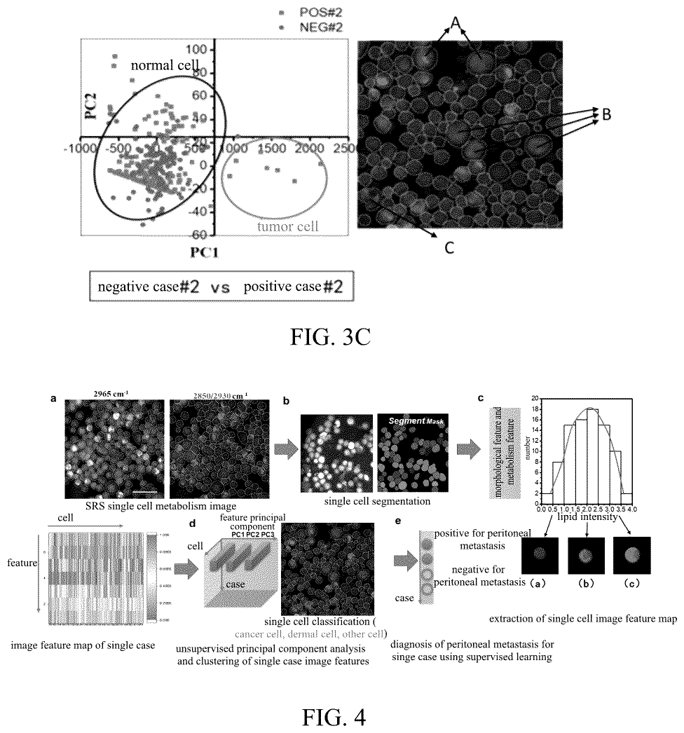

As shown in FIG. 3A, it shows a distribution diagram of lipid intensity in an obtained single cell image feature map corresponding to a single cell metabolism image. It may be seen from the distribution diagram of the lipid intensity shown in FIG. 3A that the number of cells with lipid intensity of 1.0-3.0 in this single cell metabolism image is relatively large, and with the increase of the lipid intensity, the color of the cell is gradually deepened. As shown in FIG. 3A, when the lipid intensity is lower (for example, between 0.0 and 1.0), the color of the cell is relatively light, as shown in (a) of FIG. 3A; When the lipid intensity is large (for example, between 1.0 and 3.0), the color of the cell is dark, as shown in (b) of FIG. 3A; When the lipid intensity is very high (for example, between 3.0 and 4.0), the color of the cell is the deepest, as shown in (c) in FIG. 3A.

According to an embodiment of the present disclosure, the single cell image feature map may further include a cell morphological feature.

As an example, the cell morphological feature includes at least one of: cell area, cell shape round, cell boundary circularity, cell center, cell center eccentricity, equivalent diameter, cell perimeter, major axis length (Max Axis Length), minor axis length, major axis/minor axis ratio and major axis/minor axis rotation angle (Orientation).

In step S140, the single cell image feature map corresponding to each single cell metabolism image of the plurality of single cell metabolism images may be combined to obtain an image feature map of the target object.

According to the embodiment of the present disclosure, the combining of the single cell image feature map corresponding to each single cell metabolism image of the plurality of single cell metabolism images to obtain an image feature map of the target object includes: arranging the single cell image feature map corresponding to each single cell metabolism image of the plurality of single cell metabolism images in a predetermined order to obtain the image feature map of the target object.

As an example, the single cell image feature map corresponding to each single cell metabolism image may be sequentially combined to obtain the feature map of the target object, such as the feature map about exfoliated cells from the stomach. That is to say, the single cell image feature map corresponding to each single cell metabolism image may be arranged and combined to obtain the feature map for a single case (such as gastric cancer). As shown in FIG. 3B, the feature map obtained for this single case is shown, in which a horizontal axis represents each single cell, and its value is from the first single cell to the last single cell; a vertical axis represents features, in which seven features of the above morphological features and metabolism features are selected as examples; patterns with different shades of colors shown in an area surrounded by the horizontal axis and the vertical axis shows indicate the size of feature values; When the value of a feature is higher, its color is darker.

Continuing to refer to FIG. 1, in step S150, typing of the cell may be performed by clustering the image feature map of the target object, wherein the typing indicates a cell type to which the cell belongs.

According to the embodiment of the present disclosure, the performing of the typing of the cell by clustering the image feature map of the target object may include: clustering the image feature map of the target object to obtain the number of different types of cells; performing the typing of the cell based on the number of the different types of cells.

As an example, the image feature map of the target object may be clustered by at least one of following ways to obtain the number of different types of cells: K-means clustering way, hierarchical clustering way, self-organizing map (SOM) clustering way and fuzzy c-means (FCM) clustering way.

As an example, the cell type may include a cancer cell, an immune cell (such as a neutrophil and an eosinophil), a lymph cell, a dermal cell, an epithelial cell, a blood cell or a granulocyte.

As an example, the typing of the cell may be performed based on the number of the different types of cells by at least one of following classifiers: a support vector machine learning (SVM) classifier, a linear discriminant classifier, a K nearest neighbor (KNN) classifier, logistic regression (LR) classifier, random forest (RF) decision tree classifier, artificial neural network (ANN) classifier and deep learning convolutional neural network (such as AlexNet, ResNet, Inception, NasNet, VGG, etc.) classifier.

The above clustering way may help to gather the same or similar features together, so as to get the number of different types of cells, and then the type of a cell may be determined according to the average value of all feature values of the same type after clustering. For example, the number of cells of the first type is 2000, the number of cells of the second type is 1000, and the number of cells of the third type is 10000, and the average value obtained for all feature values of the first type is, for example, 1.3, the average value obtained for all feature values of the second type is, for example. 0.8, and the average value obtained for all feature values of the third type is, for example, 2.2, whereas, for example, according to clinical trials, epithelial cells with an average value below 1, lymphocytes with an average value between 1 and 2, and cancer cells with an average value between 2 and 3 are set in advance. From the above results, it can be seen that the first type of cells are lymphocytes, the second type of cells are epithelial cells, and the third type of cells are cancer cells. These are only illustrative examples, and those skilled in the art can flexibly set corresponding values according to actual conditions.

According to an embodiment of the present disclosure, the cell segmentation and typing method provided by the present disclosure may further include (not shown in FIG. 1): performing principal component analysis on the image feature map of the target object to obtain principal component information corresponding to each single cell image feature map, wherein the principal component information of different types of cells is different; obtaining a metabolism feature target of the same type of cells based on the principal component information; determining a lesion degree of the target object according to the metabolism feature target.

As an example, the performing of the principal component analysis (PCA) on the image feature map of the target object is helpful to reduce the dimension of the obtained cell features, thus facilitating the quantification of each feature.

As an example, the principal component information of different types of cells is different, and based on the principal component information, the metabolism feature target (also called significant feature point) of the same type of cells may be obtained, which is helpful to obtain a center position of metabolism features of the same type of exfoliated cells. For example, after principal component analysis, all the features of a single cell are performed dimension reduction to three features, and then all the features of each single cell of the same type after the dimension reduction are summarized and analyzed to determine the center position of metabolism features of this type of cells, that is, the metabolism feature target.

As an example, the principal components of cancer cells' metabolism features are obviously different from those of other types of exfoliated cells. After the single cell segmentation and typing is realize through the above-mentioned principal component analysis and unsupervised learning clustering algorithm, the schematic diagram of cancer cells and normal cells as shown in FIG. 3C is obtained, in which POS represents a positive case, NEG represents a negative case, and PC1 and PC2 are the axes of principal component analysis, which are orthogonal; In FIG. 3C, the area of normal cells is circled by a big circle, and the area of tumor cells is circled by a small circle, where each point represents a cell; A, B and C in FIG. 3C indicate the location of tumor cells in the cell metabolism image.

It can be known from the single cell typing being realized by the unsupervised learning clustering algorithm, the method provided by the present disclosure may realize high-precision single cell typing without a large number of SRS images and manual labeling, which further shortens the development cycle of a related model. In addition, the principal component analysis combined with the clustering method quantifies the number of different types of exfoliated cells and metabolism feature target, as the feature input for training, for example, a gastric cancer peritoneal diagnosis model, and it is more accurate than the machine learning model trained by inputting unprocessed image features.

According to the embodiment of the present disclosure, the determining a lesion degree of the target object according to the metabolism feature target may include: inputting the number of the different types of cells and the metabolism feature target of the same type of cells into a pre-trained machine learning classification model to determine the lesion degree of the target object.

As an example, taking the gastric cancer as an example, for example, the number of cancer cells, the number of epithelial cells, the number of immune cells, the number of blood cells, the metabolism feature target of cancer cells, the metabolism feature target of epithelial cells, the metabolism feature target of immune cells and the metabolism feature target of blood cells, and the corresponding actual detection results (such as early cancer, middle cancer, middle and terminal cancer and terminal cancer) may be input into a machine learning classification model for training, and thus the pre-trained machine learning classification model may be obtained.

By inputting the number of different types of cells and the metabolism feature target of the same type of cells into the pre-trained machine learning classification model, the lesion degree of the target object may be quickly and accurately determined, so that the target object may be quickly and accurately diagnosed. For example, determining that the lesion degree of the target object is positive for peritoneal metastasis may help to quickly and accurately diagnose a result of “terminal cancer”, thereby helping doctors to carry out a targeted treatment.

It can be known from the above-mentioned cell segmentation and typing method based on machine learning provided by the present disclosure in combination with FIG. 1 to FIG. 3C, the method provided by the present disclosure can achieve high-precision single cell segmentation without a large number of SRS images and manual labeling, due to realizing the single cell segmentation by using the transfer learning and realizing the single cell typing by using the unsupervised learning clustering method, which greatly shortens the development cycle of the model. In addition, because the principal component analysis combined with the clustering method quantifies the number of different types of exfoliated cells and metabolism feature target, the trained machine learning model has higher accuracy. It can also be seen from the above contents that the method provided by the present disclosure will not be influenced by the subjective factors of pathologists, and can avoid damage to the cell morphology and realize accurate cell typing, so that the clinical application of the single cell metabolism imaging technology is greatly promoted.

In order to make the cell segmentation and typing method based on machine learning provided by the present disclosure more clear, the above method provided by the present disclosure will be explained in the form of an example.

FIG. 4 shows an example diagram of the cell segmentation and typing method according to an embodiment of the present disclosure.

Referring to FIG. 4, in step a, based on Raman imaging technology, two SRS single cell metabolism images were obtained through a protein channel and a lipid channel for exfoliated cells obtained from a stomach of a patient with the gastric cancer.

In step b, the single cell segmentation is performed on the two SRS single cell metabolism images respectively by using a machine learning segmentation model to obtain a plurality of single cell metabolism images, as shown in the figure.

In step c, the single cell feature extraction is performed on each single cell metabolism image segmented from the two SRS single cell metabolism images, wherein the extracted features include eight features: lipid intensity, lipid/protein intensity ratio, ratio of lipid component to total cell area, ratio of protein component to total cell area, lipid/protein concentration ratio in lipid component range, cell shape round, cell center eccentricity and major axis/minor axis ratio. The single cell features extracted for each single cell metabolism image are combined together to obtain the single cell image feature map corresponding to the single cell metabolism image (the lipid intensity distribution map therein is shown in the figure), and the single cell image feature map corresponding to each single cell metabolism image in the two SRS single cell metabolism images are sequentially combined to obtain the feature map for the gastric cancer, as shown in the figure.

In step d, the clustering (that is, using unsupervised learning method) and principal component analysis is performed on the feature map of the gastric cancer case to obtain the number of different types of cells and the metabolism feature target of the same type of cells. The figure shows the schematic diagram of three components PC1, PC2 and PC3 of the principal component analysis of each single cell for this case and the effect diagram of single cell classification.

In step e, the number of different types of cells and the metabolism feature target of the same type of cells obtained in step d are input into a pre-trained machine learning classification model (that is, a model adopting the supervised learning method), so that it is determined that the case of gastric cancer is positive for peritoneal metastasis, indicating that it has reached the terminal cancer.

As can be seen from the cell segmentation and typing method provided by the present disclosure, which is described in detail with reference to FIG. 4 as an example, the method provided by the present disclosure well combines the supervised learning and the unsupervised learning, improves the accuracy of the cell segmentation and typing and determining the lesion degree of the target object, avoids being influenced by the subjective factors of pathologists, and does not cause damage to the cell morphology.

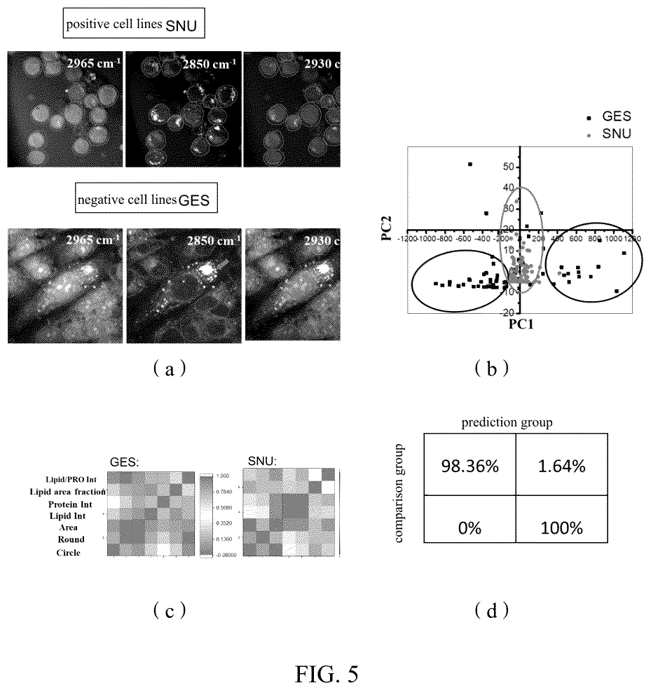

The above method provided by the present disclosure has an excellent effect in the detection of exfoliated cells of the lung cancer and the gastric cancer, as shown in FIGS. 5 to 7.

FIG. 5 shows an effect diagram of single cell typing for positive cell lines and negative cell lines. In FIG. 5, cell lines are used to verify abnormal lipid metabolism in gastric cancer cells. Two cell lines were selected for testing, namely, a positive cell line (such as SNU) and a negative cell line (such as GES). Seven cell metabolism features are selected for extraction, namely lipid/protein intensity ratio (Lipid/PRO Int), ratio of lipid component to total cell area (Lipid Area fraction), protein intensity (Lipid Int), lipid intensity (lipid int), cell area (Area), cell shape round (Round) and cell boundary circularity (Circle). (a) in FIG. 5 shows a multi-channel SRS image; (b) shows an effect diagram after the principal component analysis and clustering; (c) shows self-correlation coefficients of the cell metabolism feature; (d) shows the sensitivity and specificity of the single cell typing through cross-validation and statistics, in which the accuracy rate of the true positive is 98.36%, the error rate of the false positive is 1.64%, the error rate of the false negative is 0%, and the accuracy rate of true negative is 100%. As can be seen from the figure, the accuracy of the cell typing achieved by the method provided by the present disclosure is 98.36% and the specificity is 100%.

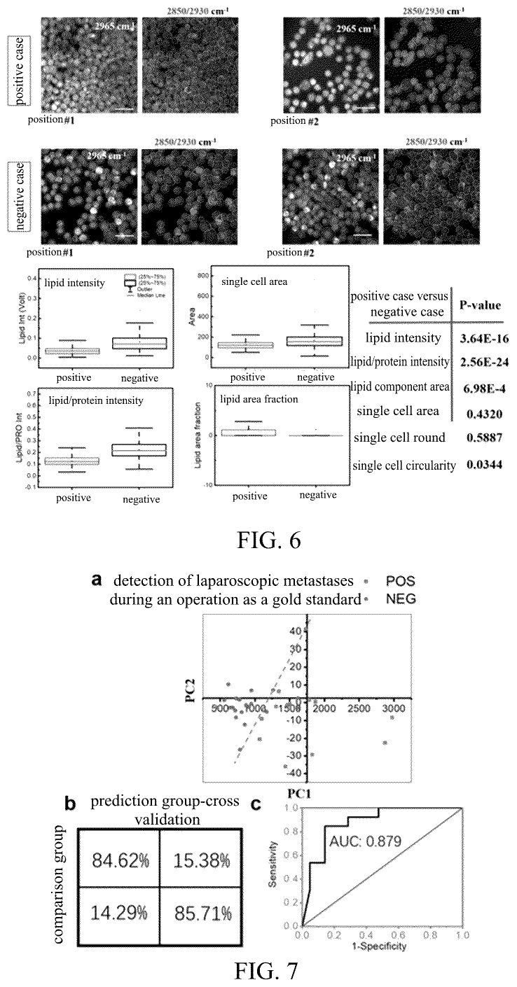

FIG. 6 shows a schematic diagram of values of a significant difference parameter (p-value) of metabolism features. Referring to FIG. 6, the metabolism features of exfoliated cells from peritoneal lavage of a peritoneal metastasis/non-metastasis case of gastric cancer were statistically compared. From comparing between peritoneal metastasis and non-metastasis cases, the metabolism features of the single cell are obviously different, and the p-value of metabolism features is smaller than that of morphological features, which further proves that the metabolism and morphological information provided by the single cell metabolism imaging technology was more accurate in the diagnosis of peritoneal metastasis than that provided by traditional detection methods only morphological information. That is to say, it can be seen from the results shown in FIG. 6 that the single cell image feature map including cell metabolism features extracted by the method provided by the present disclosure can be more accurate in determining the lesion degree of the gastric cancer than the traditional method of extracting only cell morphological features.

FIG. 7 is a schematic diagram showing sensitivity and specificity of realizing diagnosis of a peritoneal metastasis case of a gastric cancer using single cell metabolism imaging. The metabolism features of exfoliated cells of 34 cases are preliminarily studied, the number of exfoliated cells and metabolism feature target in a single case are extracted, and the prediction of the peritoneal metastasis/non-metastasis of the gastric cancer is realized by a machine learning algorithm. The sensitivity and specificity of a machine learning diagnosis model were performed cross-validation and statistics based on detection results of laparoscopic metastases during an operation as a gold standard.

Reference is made to FIG. 7, in which (a) is the principal component of metabolism features of cancer cells (such as abnormal lymphocytes) compared with 34 positive (POS) cases and negative (NEG) cases, (b) is the cross-validation result, and (c) is area under curve (AUC) calculated by plotting the sensitivity and specificity curves. It can be seen from FIG. 7 that the sensitivity and specificity achieved by the method provided by the present disclosure are 84.625% and 85.71%, respectively, and the area under curve (AUC)=0.879.

It can be known based on the detailed experimental data of FIGS. 5 to 7 that the accuracy of the single cell segmentation based on the method provided by the present disclosure is about 95%; The accuracy of single cell typing for positive/negative cell lines through validation is over 98%; The metabolism features of single cell in negative/positive gastric cancer cases are significantly different, and the p-value was much less than 0.05. The sensitivity and specificity of the single cell metabolism imaging for predicting the peritoneal metastasis reaches 85%, the ROC curve is generated by plotting the relationship between sensitivity and (1-specificity), and the area under curve (AUC=0.89) is calculated.

In addition, experiments are carried out by taking the detection of exfoliated cells of a pancreatic cancer as an example.

Specifically, a small number of pancreatic cancer exfoliated cells were extracted from a pancreatic tissue of pancreatic cancer cases and smeared. After the same sample processing, sample imaging and imaging data analysis, each sample was used to distinguish normal tissue/margin tissue/cancer tissue, so as to realize intraoperative margin detection.

The experimental data obtained are as follows: (1) There are significant differences in the metabolism features of single cells between the normal tissue and the cancer tissue. and the p-value is far less than 0.05; The sensitivity and specificity of single cell metabolism imaging for the typing of exfoliated cells reach 70% and 85%, and the ROC curve was generated by plotting the relationship between the sensitivity and (1-specificity), and the area under curve (AUC=0.8) was calculated; The sensitivity and specificity of the single cell metabolism imaging for detecting tissue margin reach 98% and 98%, the ROC curve is generated by plotting the relationship between the sensitivity and (1-specificity), and the area under curve (AUC=0.98) is calculated.

It can also be concluded from the above experiments that the cell segmentation and typing method provided by the present disclosure has high sensitivity and specificity, and can be well applied to the clinic, which provides an effective, rapid and accurate new method for cancer treatment.

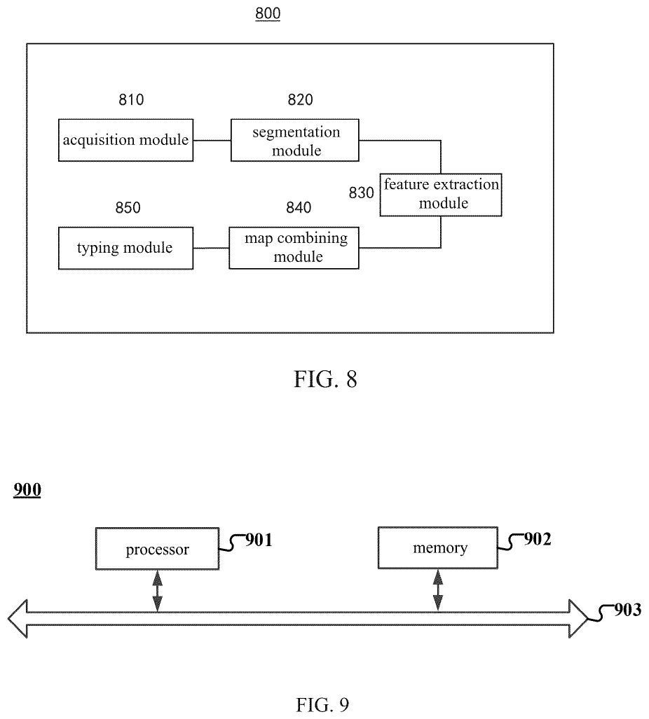

In addition to the cell segmentation and typing method based on machine learning, the present disclosure also provides a cell segmentation and typing device based on machine learning. This will be described below with reference to FIG. 8.

FIG. 8 shows a block diagram of a cell segmentation and typing device 800 based on machine learning according to an embodiment of the present disclosure. The above description of the cell segmentation and typing method based on machine learning is equally applicable to the device 800, unless otherwise explicitly stated.

Referring to FIG. 8, the device 800 may include an acquisition module 810, a segmentation module 820, a feature extraction module 830, a map combining module 840 and a typing module 850.

According to an embodiment of the present disclosure, the acquisition module 810 may be configured to acquire at least one cell metabolism image of a target object.

As an example, the target object may be an organ or tissue such as a stomach and lung in a human body. The target object can also be exfoliated cells obtained from an organ or tissue in the human body, such as exfoliated cells obtained from the stomach, to judge the situation of gastric cancer cells.

As an example, the cell metabolism image may be an image based on Raman imaging.

As an example, the cell metabolism image can be obtained through a channel, such as a protein channel, a lipid channel or a DNA channel.

As another example, the cell metabolism image may be obtained through a plurality of channels, for example, three channels including a protein channel, a lipid channel and a DNA channel.

As an example, for a single case (such as a gastric cancer case or a lung cancer case), the above-mentioned at least one cell metabolism image may be obtained through one or more channels.

According to an embodiment of the present disclosure, the segmentation module 820 may be configured to perform single cell image segmentation on the at least one cell metabolism image by using a machine learning segmentation model to obtain a plurality of single cell metabolism images.

As an example, the segmentation module 820 may include: performing the single cell image segmentation on the at least one cell metabolism image by using a neural network based on transfer learning to obtain the plurality of single cell metabolism images.

The above contents may be trained by the transfer learning using an existing database and neural network segmentation model for the single cell segmentation (such as a database and neural network segmentation model about the single cell segmentation of a fluorescence image), and a small amount of stimulated Raman cell images and manual labeling data, that is, the machine learning segmentation model that needs to be used may be obtained, so as to realize high-precision segmentation for the single cell metabolism image.

Different from the traditional image segmentation method based on neural network algorithm, the image segmentation method provided by the present disclosure avoids the collection of a large number of clinical data and a large number of manual (such as pathologists and experts) labeling due to using the machine learning segmentation model based on the transfer learning, which greatly shortens the development cycle of a related learning model and greatly promotes the clinical application of single cell metabolism imaging technology.

As another example, the segmentation module 820 may include a first time segmentation module configured to perform the single cell image segmentation for a first time on the at least one cell metabolism image by using a neural network based on transfer learning; a second time segmentation module configured to perform segmentation for a second time on an image after the single cell segmentation for the first time by using a watershed segmentation method or a flood-fill segmentation method, to obtain the plurality of single cell metabolism images.

According to an embodiment of the present disclosure, the feature extraction module 830 may be configured to perform single cell feature extraction on each single cell metabolism image of the plurality of single cell metabolism images to obtain a single cell image feature map corresponding to the single cell metabolism image, wherein the single cell image feature map at least includes a cell metabolism feature.

As an example, single cell features may be extracted by any known way, such as measurement, calculation, etc. A plurality of single cell features may be extracted from each single cell metabolism image, and the single cell image feature map may be obtained by combining (such as arranging) the plurality of single cell features.

As an example, the cell metabolism feature may include at least one of: lipid intensity, lipid concentration, protein intensity, protein concentration, deoxyribonucleic acid (DNA) concentration, lipid/protein intensity ratio, lipid/protein concentration ratio. lipid/deoxyribonucleic acid concentration ratio, the number of lipid droplets, lipid droplet area, ratio of lipid droplet area to total cell area, lipid/protein concentration ratio in lipid droplet range, lipid component/protein component area ratio, lipid component/deoxyribonucleic acid component area ratio, ratio of lipid component to total cell area (Lipid Area Fraction), ratio of protein component to total cell area, and lipid/protein concentration ratio in lipid component range.

According to an embodiment of the present disclosure, the single cell image feature map may further include a cell morphological feature.

As an example, the cell morphological feature includes at least one of: cell area, cell shape round, cell boundary circularity, cell center, cell center eccentricity, equivalent diameter, cell perimeter, major axis length (Max Axis Length), minor axis length, major axis/minor axis ratio and major axis/minor axis rotation angle (Orientation).

According to an embodiment of the present disclosure, the map combining module 840 may be configured to combine the single cell image feature map corresponding to each single cell metabolism image of the plurality of single cell metabolism images to obtain an image feature map of the target object.

As an example, the map combining module 840 may include arranging the single cell image feature map corresponding to each single cell metabolism image of the plurality of single cell metabolism images in a predetermined order to obtain the image feature map of the target object. For example, the single cell image feature map corresponding to each single cell metabolism image may be sequentially combined to obtain the feature map of the target object, such as the feature map about exfoliated cells from the stomach. That is to say, the single cell image feature map corresponding to each single cell metabolism image may be arranged and combined to obtain the feature map for a single case (such as gastric cancer).

According to an embodiment of the present disclosure, the typing module 850 may be configured to perform typing of the cell by clustering the image feature map of the target object, wherein the typing indicates a cell type to which the cell belongs.

As an example, the typing module 850 may include: clustering the image feature map of the target object to obtain the number of different types of cells; performing the typing of the cell based on the number of the different types of cells.

As an example, the image feature map of the target object may be clustered by at least one of following ways to obtain the number of different types of cells: K-means clustering way, hierarchical clustering, self-organizing map (SOM) clustering way and fuzzy c-means (FCM) clustering way.

As an example, the cell type may include a cancer cell, an immune cell (such as a neutrophil and an eosinophil), a lymph cell, a dermal cell, an epithelial cell, a blood cell or a granulocyte.

As an example, the typing of the cell may be performed based on the number of the different types of cells by at least one of following classifiers: a support vector machine learning (SVM) classifier, a linear discriminant classifier, a K nearest neighbor (KNN) classifier, logistic regression (LR) classifier, random forest (RF) decision tree classifier, artificial neural network (ANN) classifier and deep learning convolutional neural network (such as AlexNet, ResNet, Inception, NasNet, VGG, etc.) classifier.

The above clustering method may help to gather the same or similar features together, so as to get the number of different types of cells, and then the type of a cell may be determined according to the average value of all feature values of the same type after clustering. For example, the number of cells of the first type is 2000, the number of cells of the second type is 1000, and the number of cells of the third type is 10000, and the average value obtained for all feature values of the first type is, for example, 1.3, the average value obtained for all feature values of the second type is, for example, 0.8, and the average value obtained for all feature values of the third type is, for example, 2.2, whereas, for example, according to clinical trials, epithelial cells with an average value below 1, lymphocytes with an average value between 1 and 2, and cancer cells with an average value between 2 and 3 are set in advance. From the above results, it can be seen that the first type of cells are lymphocytes, the second type of cells are epithelial cells, and the third type of cells are cancer cells. These are only illustrative examples, and those skilled in the art can flexibly set corresponding values according to actual conditions.

According to an embodiment of the present disclosure, the cell segmentation and typing device provided by the present disclosure may further include (not shown in FIG. 8): a principal component analysis module, a target obtaining module and a lesion determination module, wherein the principal component analysis module may be configured to perform principal component analysis on the image feature map of the target object to obtain principal component information corresponding to each single cell image feature map, wherein the principal component information of different types of cells is different; the target obtaining module may be configured to obtain metabolism feature target of the same type of cells based on the principal component information; the lesion determination module may be configured to determine a lesion degree of the target object according to the metabolism feature target.

As an example, the performing of the principal component analysis (PCA) on the image feature map of the target object is helpful to reduce the dimension of the obtained cell features, thus facilitating the quantification of each feature.

According to an embodiment of the present disclosure, the lesion determination module includes: inputting the number of the different types of cells and the metabolism feature target of the same type of cells into a pre-trained machine learning classification model to determine the lesion degree of the target object.

As an example, taking the gastric cancer as an example, for example, the number of cancer cells, the number of epithelial cells, the number of immune cells, the number of blood cells, the metabolism feature target of cancer cells, the metabolism feature target of epithelial cells, the metabolism feature target of immune cells and the metabolism feature target of blood cells, and the corresponding actual detection results (such as early cancer, middle cancer, middle and terminal cancer and terminal cancer) may be input into a machine learning classification model for training, and thus the pre-trained machine learning classification model may be obtained.

By inputting the number of different types of cells and the metabolism feature target of the same type of cells into the pre-trained machine learning classification model, the lesion degree of the target object may be quickly and accurately determined, so that the target object may be quickly and accurately diagnosed. For example, determining that the lesion degree of the target object is positive for peritoneal metastasis may help to quickly and accurately diagnose a result of “terminal cancer”, thereby helping doctors to carry out a targeted treatment.

Since the details of the above operations have been introduced in the process of describing the cell segmentation and typing method based on machine learning according to the present disclosure, they will not be repeated here for the sake of brevity, and the relevant details may be referred to the above descriptions about FIGS. 1 to 7.

The cell segmentation and typing method and device based on machine learning according to embodiments of the disclosure have been described above with reference to FIGS. 1 to 8. However, it should be understood that each module in the device shown in FIG. 8 may be configured as software, hardware, firmware or any combination of the above items to perform a specific function, respectively. For example, these modules may correspond to dedicated integrated circuits, pure software codes, and modules combining software and hardware.

It should be noted that, although the cell segmentation and typing device 800 based on machine learning was described above as being divided into modules for respectively performing corresponding processing, it is clear to those skilled in the art that the processing performed by each module may also be performed without any specific module division or clear demarcation between modules. In addition, the device described above with reference to FIG. 8 is not limited to the modules described above, but some other modules (e.g., a storage module, a data processing module, etc.) may be added as needed. or the above modules may also be combined.

In addition, the cell segmentation and typing method based on machine learning according to the present disclosure may be recorded in a computer-readable recording medium. Specifically, according to the present disclosure, a computer-readable recording medium storing computer-executable instructions may be provided, wherein the computer-executable instructions, when executed by a processor, may cause a processor to perform the cell segmentation and typing method based on machine learning as described above. Examples of the computer-readable recording media may include a magnetic media (such as a hard disk, a floppy disk, and a magnetic tape); an optical media (such as a CD-ROM and a DVD); a magneto-optical media (for example, an optical disk), and a specially designed hardware device (e.g., a read-only memory (ROM), a random access memory (RAM), a flash memory, etc.) for storing and executing program instructions.

In addition, the present disclosure also provides a cell segmentation and typing apparatus based on machine learning, which will be described with reference to FIG. 9.

FIG. 9 shows a structural diagram of a cell segmentation and typing apparatus 900 based on machine learning according to an embodiment of the present disclosure. The above description of the cell segmentation and typing method based on machine learning is equally applicable to the apparatus 900, unless otherwise explicitly stated.

Referring to FIG. 9, the apparatus 900 may include a processor 901 and a memory 902. Both the processor 901 and the memory 902 may be connected by a bus 903.

The processor 901 may perform various actions and processes according to programs stored in the memory 902. Specifically, the processor 901 may be an integrated circuit chip with signal processing capability. The processor may be a general processor, a digital signal processor (DSP), an application specific integrated circuit (ASIC), a field programmable gate array (FPGA) or other programmable logic devices, a discrete gate or transistor logic device, and a discrete hardware component. The methods, steps and logic blocks disclosed in embodiments of the present application may be realized or executed. The general processor may be a microprocessor or it may be any conventional processor and so on, and it may be in a form of X86 architecture or ARM architecture.

The memory 902 stores computer-executable instructions, which, when executed by the processor 901, realize the above-mentioned cell segmentation and typing method based on machine learning. The memory 902 may be a volatile memory or a nonvolatile memory, or may include both the volatile memory and the nonvolatile memory. The nonvolatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), which is used as an external cache. By way of illustration but not limitation, RAMs in many forms are available, such as a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous connection dynamic random access memory (SLDRAM) and a direct memory bus random access memory (DR RAM). It should be noted that the memory of the method described herein is intended to include, but are not limited to, these and any other suitable types of memories.

It should be noted that the flowcharts and block diagrams in the drawings illustrate the possible architectures, functions and operations of systems, methods and computer program products according to various embodiments of the present disclosure. In this regard, each block in the flowchart or block diagram may represent a module, a program segment, or a part of code, which contains at least one executable instruction for implementing a specified logical function. It should also be noted that in some alternative implementations, the functions noted in the blocks may occur in a different order from those noted in the drawings. For example, two blocks shown in succession may actually be executed substantially in parallel, and they may sometimes be executed in a reverse order, depending on the functions involved. It should also be noted that each block in the block diagrams and/or flowcharts, and combinations of blocks in the block diagrams and/or flowcharts, may be implemented by a dedicated hardware-based system that performs specified functions or operations, or by a combination of a dedicated hardware and computer instructions.

In general, various example embodiments of the present disclosure may be implemented in hardware or dedicated circuits, software, firmware, logic, or any combination thereof. Some aspects may be implemented in hardware, while other aspects may be implemented in firmware or software that may be executed by a controller, microprocessor or other computing device. When aspects of the embodiments of the present disclosure are illustrated or described as block diagrams, flowcharts, or represented using some other graphics, it will be understood that the blocks, devices, systems, techniques, or methods described herein may be implemented in hardware, software, firmware, special-purpose circuits or logic, general-purpose hardware or controllers or other computing devices, or some combination thereof, as non-limiting examples.

The exemplary embodiments of the present disclosure described in detail above are only illustrative, not restrictive. It should be understood by those skilled in the art that various modifications and combinations may be made to these embodiments or their features without departing from the principles and spirit of the present disclosure, and such modifications should fall within the scope of the present disclosure.

1. A cell segmentation and typing method based on machine learning, comprising:
acquiring at least one cell metabolism image of a target object;
performing single cell image segmentation on the at least one cell metabolism image by using a machine learning segmentation model to obtain a plurality of single cell metabolism images;
performing single cell feature extraction on each single cell metabolism image of the plurality of single cell metabolism images to obtain a single cell image feature map corresponding to the single cell metabolism image, wherein the single cell image feature map at least comprises a cell metabolism feature;
combining the single cell image feature map corresponding to each single cell metabolism image of the plurality of single cell metabolism images to obtain an image feature map of the target object;
performing typing of the cell by clustering the image feature map of the target object, wherein the typing indicates a cell type to which the cell belongs.

2. The cell segmentation and typing method according to claim 1, wherein the performing typing of the cell by clustering the image feature map of the target object comprises:
clustering the image feature map of the target object to obtain the number of different types of cells;
performing the typing of the cell based on the number of the different types of cells.

3. The cell segmentation and typing method according to claim 2,
wherein the image feature map of the target object is clustered by at least one of following ways to obtain the number of different types of cells: K-means clustering way, hierarchical clustering way, self-organizing map clustering way and fuzzy c-means clustering way; or wherein the typing of the cell is performed based on the number of the different types of cells by at least one of following classifiers: a support vector machine classifier, a linear discriminant classifier, a K neighborhood classifier, a logistic regression classifier, a random forest decision tree classifier, an artificial neural network classifier and a deep learning convolutional neural network classifier.

4. (canceled)

5. The cell segmentation and typing method according to claim 2, wherein the method further comprises:
performing principal component analysis on the image feature map of the target object to obtain principal component information corresponding to each single cell image feature map, wherein the principal component information of different types of cells is different;
obtaining a metabolism feature target of the same type of cells based on the principal component information;
determining a lesion degree of the target object according to the metabolism feature target.

6. The cell segmentation and typing method according to claim 5, wherein the determining a lesion degree of the target object according to the metabolism feature target comprises:
inputting the number of the different types of cells and the metabolism feature target of the same type of cells into a pre-trained machine learning classification model to determine the lesion degree of the target object.

7. The cell segmentation and typing method according to claim 1,
wherein the performing single cell image segmentation on the at least one cell metabolism image by using a machine learning segmentation model to obtain a plurality of single cell metabolism images comprises: performing the single cell image segmentation on the at least one cell metabolism image by using a neural network based on transfer learning to obtain the plurality of single cell metabolism images;
or
wherein the performing single cell image segmentation on the at least one cell metabolism image by using a machine learning segmentation model to obtain a plurality of single cell metabolism images comprises: performing the single cell image segmentation for a first time on the at least one cell metabolism image by using a neural network based on transfer learning; performing segmentation for a second time on an image after the single cell segmentation for the first time by using a watershed segmentation method or a flood-fill segmentation method, to obtain the plurality of single cell metabolism images;
or
wherein the combining the single cell image feature map corresponding to each single cell metabolism image of the plurality of single cell metabolism images to obtain an image feature map of the target object comprises: arranging the single cell image feature map corresponding to each single cell metabolism image of the plurality of single cell metabolism images in a predetermined order to obtain the image feature map of the target object.

8. (canceled)

9. The cell segmentation and typing method according to claim 1, wherein the single cell image feature map further comprises a cell morphological feature.

10. The cell segmentation and typing method according to claim 9,
wherein the cell morphological feature comprises at least one of: cell area, cell shape round, cell boundary circularity, cell center, cell center eccentricity, equivalent diameter, cell perimeter, major axis length, minor axis length, major axis/minor axis ratio and major axis/minor axis rotation angle; or
wherein, the cell metabolism feature comprises at least one of: lipid intensity, lipid concentration, protein intensity, protein concentration, deoxyribonucleic acid concentration, lipid/protein intensity ratio, lipid/protein concentration ratio, lipid/deoxyribonucleic acid concentration ratio, the number of lipid droplets, lipid droplet area, ratio of lipid droplet area to total cell area, lipid/protein concentration ratio in lipid droplet range, lipid component/protein component area ratio, lipid component/deoxyribonucleic acid component area ratio, ratio of lipid component to total cell area, ratio of protein component to total cell area and lipid/protein concentration ratio in lipid component range.

11. (canceled)

12. (canceled)

13. The cell segmentation and typing method according to claim 1,
wherein the cell metabolism image is an image based on Raman imaging;
or
wherein the cell type comprises a cancer cell, an immune cell, a lymph cell, a dermal cell, an epithelial cell, a blood cell or a granulocyte.

14. (canceled)

15. A cell segmentation and typing device based on machine learning, comprising:
an acquisition module configured to acquire at least one cell metabolism image of a target object;
a segmentation module configured to perform single cell image segmentation on the at least one cell metabolism image by using a machine learning segmentation model to obtain a plurality of single cell metabolism images;
a feature extraction module configured to perform single cell feature extraction on each single cell metabolism image of the plurality of single cell metabolism images to obtain a single cell image feature map corresponding to the single cell metabolism image, wherein the single cell image feature map at least comprises a cell metabolism feature;
a map combining module configured to combine the single cell image feature map corresponding to each single cell metabolism image of the plurality of single cell metabolism images to obtain an image feature map of the target object;
a typing module configured to perform typing of the cell by clustering the image feature map of the target object, wherein the typing indicates a cell type to which the cell belongs.

16. The cell segmentation and typing device according to claim 15, wherein the typing module comprises:
clustering the image feature map of the target object to obtain the number of different types of cells;
performing the typing of the cell based on the number of the different types of cells.

17. The cell segmentation and typing device according to claim 16,
wherein the image feature map of the target object is clustered by at least one of following ways to obtain the number of different types of cells: K-means clustering way, hierarchical clustering way, self-organizing map clustering way and fuzzy c-means clustering way; or wherein the typing of the cell is performed based on the number of the different types of cells by at least one of following classifiers: a support vector machine classifier, a linear discriminant classifier, a K neighborhood classifier, a logistic regression classifier, a random forest decision tree classifier, an artificial neural network classifier and a deep learning convolutional neural network classifier.

18. (canceled)

19. The cell segmentation and typing device according to claim 16, wherein the device further comprises:
a principal component analysis module configured to perform principal component analysis on the image feature map of the target object to obtain principal component information corresponding to each single cell image feature map, wherein the principal component information of different types of cells is different;
a target obtaining module configured to obtain metabolism a feature target of the same type of cells based on the principal component information;
a lesion determination module configured to determine a lesion degree of the target object according to the metabolism feature target.

20. The cell segmentation and typing device according to claim 19, wherein the lesion determination module comprises:
inputting the number of the different types of cells and the metabolism feature target of the same type of cells into a pre-trained machine learning classification model to determine the lesion degree of the target object.

21. The cell segmentation and typing device according to claim 15,
wherein the segmentation module comprises: performing the single cell image segmentation on the at least one cell metabolism image by using a neural network based on transfer learning to obtain the plurality of single cell metabolism images; or
wherein the segmentation module comprises: a first time segmentation module configured to perform the single cell image segmentation for a first time on the at least one cell metabolism image by using a neural network based on transfer learning; a second time segmentation module configured to perform segmentation for a second time on an image after the single cell segmentation for the first time by using a watershed segmentation method or a flood-fill segmentation method, to obtain the plurality of single cell metabolism images.

22. (canceled)

23. The cell segmentation and typing device according to claim 15, wherein the single cell image feature map further comprises a cell morphological feature.

24. The cell segmentation and typing device according to claim 23,
wherein the cell morphological feature comprises at least one of: cell area, cell shape round, cell boundary circularity, cell center, cell center eccentricity, equivalent diameter, cell perimeter, major axis length, minor axis length, major axis/minor axis ratio and major axis/minor axis rotation angle; or
wherein, the cell metabolism feature comprises at least one of: lipid intensity, lipid concentration, protein intensity, protein concentration, deoxyribonucleic acid concentration, lipid/protein intensity ratio, lipid/protein concentration ratio, lipid/deoxyribonucleic acid concentration ratio, the number of lipid droplets, lipid droplet area, ratio of lipid droplet area to total cell area, lipid/protein concentration ratio in lipid droplet range, lipid component/protein component area ratio, lipid component/deoxyribonucleic acid component area ratio, ratio of lipid component to total cell area, ratio of protein component to total cell area and lipid/protein concentration ratio in lipid component range.

25. (canceled)

26. The cell segmentation and typing device according to claim 15, wherein the map combining module comprises:
arranging the single cell image feature map corresponding to each single cell metabolism image of the plurality of single cell metabolism images in a predetermined order to obtain the image feature map of the target object.

27. The cell segmentation and typing device according to claim 15,
wherein the cell metabolism image is an image based on Raman imaging; or
wherein the cell type comprises a cancer cell, an immune cell, a lymph cell, a dermal cell, an epithelial cell, a blood cell or a granulocyte.

28. (canceled)

29. A cell segmentation and typing apparatus based on machine learning, comprising:
a processor, and a memory storing computer-executable instructions which, when executed by the processor, cause the processor to:
acquire at least one cell metabolism image of a target object;
perform single cell image segmentation on the at least one cell metabolism image by using a machine learning segmentation model to obtain a plurality of single cell metabolism images;
perform single cell feature extraction on each single cell metabolism image of the plurality of single cell metabolism images to obtain a single cell image feature map corresponding to the single cell metabolism image, wherein the single cell image feature map at least comprises a cell metabolism feature;
combine the single cell image feature map corresponding to each single cell metabolism image of the plurality of single cell metabolism images to obtain an image feature map of the target object;
perform typing of the cell by clustering the image feature map of the target object, wherein the typing indicates a cell type to which the cell belongs.

30. (canceled)
